(19) United States
(12) Patent Application Publication
(10) Pub. No.: US 2012/0193410 A1
(43) Pub. Date: Aug. 2, 2012

(54) PLANT AND METHOD FOR IDENTIFICATION OF GAUZES IN SURGERY ROOM

(76) Inventor: Diego Benetti, Concesio (BS) (IT)

(21) Appl. No.: 13/496,939

(22) PCT Filed: Sep. 21, 2009
(86) PCT No.: PCT/IT2009/000426

§ 371 Date: Apr. 4, 2012

(51) Int. Cl. G06F 17/00

(52) U.S. Cl. 235/375

(57) ABSTRACT

A plant and a method for identifying gauzes in a surgery room are described, wherein each gauze incorporates at least one means containing identification data for remotely detecting the presence of each gauze, the plant includes at least one device for detecting means containing identification data of the gauzes, at least one apparatus for processing data transmitted by the detection device, and a plurality of probes placed in different locations of said surgery room and connected to the detection device.

### FIELD OF THE INVENTION

The present invention refers to a plant and a method for allowing the identification of data concerning the gazes used in a surgery room.

It is well known that during the surgical operations a lot of sterile gauzes are used for allowing to staunch or clean the wounds from blood. Once used, the gauzes are thrown into a receptacle for hospital waste.

One of the greater dangers frequently presenting in this situation is to leave one or more gauzes inside the patient body after the wound has been sutured. This may involve serious consequences to the patient, in particular due to infections that could cause, in the worst case, the patient death too.

The problem is that the gauzes placed near the wound, once all the possible blood has been absorbed, may be in practice indistinguishable relatively to the area surrounding the wound itself, above all in case of a lot of blood dispersion in such an area.

### BACKGROUND ART

In the International Patent Application n° WO 2007/042872 in the name of the same Applicant, a system for remotely detecting gauzes has been proposed providing the use of a radiopaque filament inserted into the weft or warp of the sterile gauze.

Systems are further known for controlling the use of gauzes, medicines and surgical instruments in hospital environment, for example the International Patent Application n° WO 2005/053557 and the U.S. Patent Application n° US 2002/0143320, wherein transponders of the RFID type are used in association with such products to identify their presence and to control the product flow in the hospital environment.

### SUMMARY OF THE INVENTION

The task of the present invention is to solve the drawbacks of the prior art in a particularly critical environment such as a surgery room.

In the scope of this task, a general object of the present invention is to provide a plant and a method allowing the count and handling of sterile gauzes before, during and after the surgical operations.

A particular object of the present invention is to propose a plant and a method which allow the gauze loss prevention in a surgery room avoiding, in the worst case, their remaining into the patient body when the operation is finished.

Another object of the present invention is to suggest a plant and a method which avoid the manual count of the used gauzes by the surgery room staff.

A further object of the present invention is to suggest a plant and a method which avoid the sterile environment contamination and the staff contamination manipulating the gauzes during their count, to increase the workplace safety according to the existing regulations (for example, the 626 law).

These objects are achieved by the present invention, concerning a plant for gauze identification in a surgery room, wherein each gauze incorporates at least one means containing identification data for remotely detecting the presence of each gauze, the plant including at least one device for detecting the means containing identification data of the gauzes and at least one apparatus for processing data transmitted by the detection device. Advantageously the plant includes a plurality of probes placed in different positions of the surgery room and connected to the detection device.

The means containing the identification data incorporated in each gauze is preferably a passive transponder of the RFID type.

The probes for detecting each identification means include at least one antenna placed on the instrument trolley or the main table.

At least another antenna is placed at a receptacle for collecting the used gauzes. In particular, more antennas are provided on a moveable frame supporting the receptacle for collecting the used gauzes. These antennas are preferably relocatably mounted on the moveable frame, so as to fit with different dimension receptacles.

The antennas may be placed, for example, in locations near a side wall or a bottom wall of the receptacle for collecting the used gauzes.

The probes include a further moveable antenna inserted in a sterile covering sheath made of an appropriate material (for example: cellophane) and manually operable, to allow the detection of potential gauzes being present in the body cavities of the surgical operation, particularly to verify that no gauzes stay in touch with the patient before the end of the surgical operation.

The invention further concerns a method for identifying the gauzes in a surgery room, wherein each gauze incorporates at least one means containing identification data for remotely detecting the presence of each gauze. The process essentially includes the steps of:
a) detecting the means containing identification data in the gauzes introduced into the surgery room before the patient operation;
b) transmitting the identification data of each gauze to a processing apparatus;
c) storing the identification data of each gauze in the processing apparatus;
d) detecting the means containing the identification data in the gauzes dumped in a receptacle for collecting the gauzes used during the patient operation;
e) transmitting the identification data of each used gauze to the processing apparatus; and
f) real time updating the identification data of each gauze in the processing apparatus.

In practice, before the patient operation, the count of the gauzes introduced in the surgery room takes place by means of an antenna placed on the instrument trolley or the main table. The detected value is loaded into the processing apparatus, for example a PC provided with a software dedicated to this scope, and other information relative to the gauzes may also be verified, for example their expiration date, the production lot and similar.

During the operation, the used gauzes are progressively left in a receptacle adapted for collecting the hospital waste. The count of the used gauzes may be realized by a plurality of antennas placed in locations near a side wall or the bottom wall of the receptacle for collecting the used gauzes, such that the processing apparatus may count progressively each discarded gauze by updating the count of the remaining gauzes relatively to those initially introduced.

Before the operation end it is possible to realize some checks to establish that no gauze is remained in contact or inside the patient body. For example, the unused gauze count may be realized using the antenna housed over the bottom of the table receptacle, already used for counting the gauzes introduced into the surgery room, to ascertain the coherence between the automatically detected values of the introduced and used gauzes.

In case of mismatch of the automatically detected values, or anyway to guarantee a higher safety level, a mobile antenna is used, that may be introduced into the patient body through the surgical wound to verify the possible presence of further gauzes missed in the automatic control. The mobile antenna sterility is assured by a sterile sheath, for example a sheath made of cellophane or any other appropriate material.

### BRIEF DESCRIPTION OF THE DRAWINGS

Other characteristics and advantages of the present invention will become more evident from the description below, with reference to the accompanying drawings, in which:

FIG. 1 is a perspective view of some gauzes provided with a passive transponder of the RFID type;

FIG. 2 is a plant diagram according to a possible embodiment of the present invention;

FIG. 3 is an elevation view of a first embodiment illustrating the antenna arrangement on a side wall of the frame supporting a receptacle for collecting the hospital waste; and

FIG. 4 is a plan view of a second embodiment illustrating the antenna arrangement on the bottom wall of the frame supporting a receptacle for collecting the hospital waste.

### DESCRIPTION OF THE PREFERRED EMBODIMENTS

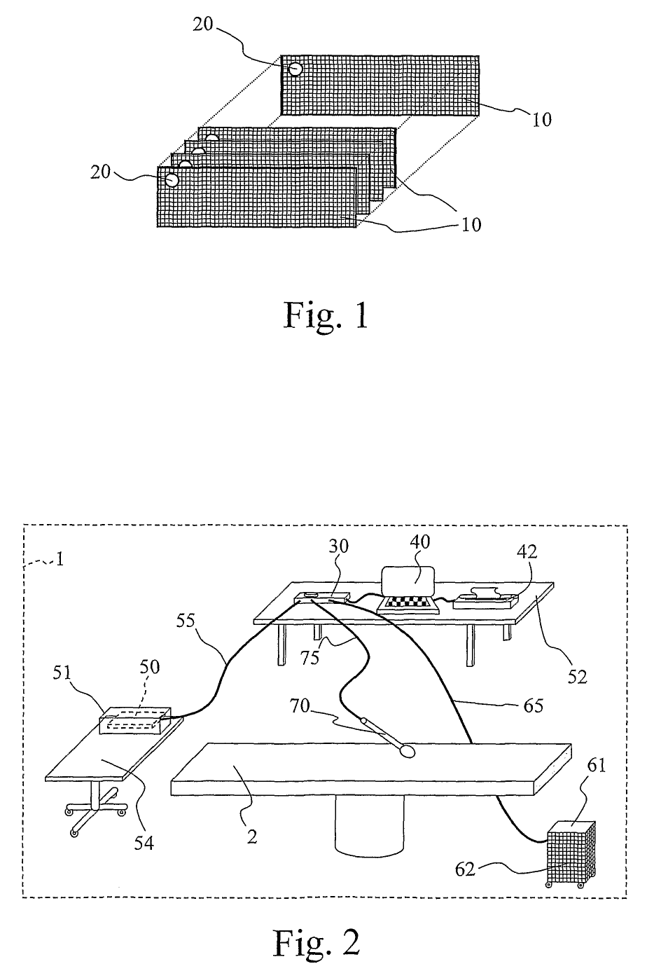

In FIG. 1 there are illustrated some sterile gauzes 10 intended for use in a surgery room according to the method of the present invention, that is gauzes incorporating at least one means containing identification data for remotely detecting the presence of each gauze.

Each sterile gauze 10 is provided with a transponder RFID 20 of the passive type realized in a little dimensioned shape having a diameter included from 10 to 30 mm with a thick not greater than 4 mm, being able to be detected by the antennas within a range of about 25-30 cm. Transponders with diameter of 23 mm and 15 mm, respectively, each one with a thick of 3.5 mm, have been tested so far with success. Anyway they are transponders made of atoxic material intended for high frequency use, for example 13.56 MHz according to the ISO 15693 standard and the CEE standard, allowing high performances in case of multiple reading too and easily available on the market at low costs.

In the diagram of FIG. 2 some essential components of a plant according to the present invention are illustrated in the sphere of a surgery room 1.

The plant includes a detecting device or reader 30 connected to an apparatus 40 for processing data detected by the reader 30 through a plurality of probes placed in different locations of the surgery room 1. The processing apparatus 40, for example consisting of a PC, may be in case connected to a printer 42 for the possible production of a papery certification document. As it is shown in FIG. 2, these components may be disposed, for example, on a table 52 far from the operating table 2.

The probes connected to the reader 30 include at least one first antenna 50 connected to the reader 30 through a coaxial cable 55. The antenna 50 may be for example placed on the bottom of a receptacle 51 resting over a flat surface that is, for example, the surface of an instrument trolley 54 near the operating table 2, or over the main table of the surgery room 1.

In fact, the gauzes 10 introduced into the surgery room at the beginning are counted and controlled by putting them into the receptacle 51 and, thanks to the high frequency technology provided for the reader 30, each package (each one containing ten gauzes) may be inserted into the receptacle 51 with the contemporaneous data reading of each gauze inside the package. By doing so, the expiration date of the gauzes 10 is further verified, such that the processing apparatus 40 may verify if they can be used before the surgical operation.

Furthermore, the antenna 50 placed into the receptacle 51 is for counting the unused gauzes 10 too before the surgical operation end, in order to verify that the sum of the used gauze amount, that are automatically counted as they are introduced into the receptacle 61 for collecting the hospital waste, and the remaining gauze amount coincides with the gauze amount initially introduced in the surgery room 1.

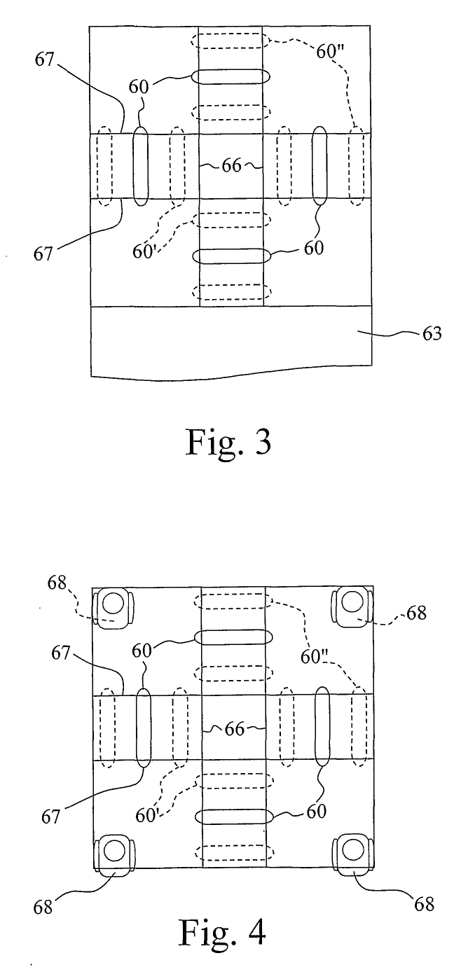

In fact a plurality of antennas 60 (FIGS. 3 and 4) are placed at a receptacle 61 for used gauze collecting. The antennas 60 are connected to the reader 30 by a coaxial cable 65.

The receptacle 61, for example a receptacle of the “HALIPAC” type, is supported by a moveable frame 62 that may be placed, during the operation, near the operating table 2 to allow the collecting of hospital waste in general. When a used gauze 10 is thrown into the receptacle 61, the antennas 60 detect the data from the transponder 20 coupled with it and the reader 61 provides their communication to the PC 40, the latter updating the used gauze count.

The plant further includes a moveable antenna 70 connected to the reader 30 by a coaxial cable. The antenna 70 has a range of 25-30 cm and may be manually used to detect possible gauzes inside the human body, or near the operating table 2 or anyway in contact with the patient. This allows to carry out possible checks in case of mismatch of automatically updated data and real time updated data from the PC 40, or any further safety control before ending the patient operation.

In practice, during the operation, the data corresponding to the gauze count are shown in real time on the monitor of the PC 40, such that the staff present in the surgery room may instantly verify if there are any possible gauzes remaining inside the patient body before the operation end.

In the view of FIG. 3 is partially represented a side wall 63 of the supporting frame 62 for a receptacle 61 intended for collecting the hospital waste, such that the antennas 60 are placed in some locations near a side wall of the receptacle 61. In the embodiment herein represented, four antennas 60 are provided, mounted on a mutually perpendicular couple tracks 66 and 67.

The antennas 60 may run and be blocked in position on the corresponding tracks between the ending positions 60′ (nearest) and 60″ (farthest), represented by dotted lines to allow their adaptation to the receptacle dimensions 61, in order to allow the reading of each transponder 20 as each used gauze 10, thrown into the receptacle, passes.

In the embodiment of FIG. 4, the antennas 60 are placed instead on the bottom wall 64 of the supporting frame, the rotating wheels 68 of which are further illustrated, allowing the easily positioning of the receptacle 61 in the most adapted location. In this case, the antennas 60 are near the bottom side of the receptacle 61 and may anyway detect the data of each gauze thrown into the receptacle 61 in a range of 25-30 cm. The mounting system of the antennas 60 on the tracks 66 and 67 is completely identical to that represented in FIG. 3.

Various modifications can be made to the embodiment herein represented without therefore falling out from the scope of the present invention. For example, also if in the whole description it has been explicitly referred to “gauzes”, it is evident that the same principles may be applied to tablets or some other similar products too that are used in the hospital environment.

1. A plant for identifying gauzes in a surgery room, wherein each of said gauzes incorporates at least one means containing identification data for remotely detecting the presence of each of said gauzes, the plant including at least one device for detecting said means containing identification data of said gauzes and at least one apparatus for processing said data transmitted by said detection device, characterized by including a plurality of probes placed in different locations of said surgery room and connected to said detection device.

2. The plant according to claim 1, wherein said means containing identification data incorporated in each of said gauzes is a passive transponder of the RFID type.

3. The plant according to claim 1, wherein said probes include at least one antenna placed on the instrument trolley or the main table.

4. The plant according to claim 3, wherein said at least one antenna is placed on the bottom of a table receptacle.

5. The plant according to claim 1, wherein said probes include at least one antenna placed at a receptacle for collecting used gauzes.

6. The plant according to claim 5, wherein said probes include a plurality of antennas mounted on a supporting moveable frame of said receptacle for collecting used gauzes.

7. The plant according to claim 6, wherein said antennas are relocatably mounted on said moveable frame in locations adjacent to a side wall of said receptacle for collecting used gauzes.

8. The plant according to claim 6, wherein said antennas are relocatably mounted on said moveable frame in locations adjacent to a bottom wall of said receptacle for collecting used gauzes.

9. The plant according to claim 1, wherein said probes include at least one manually moveable antenna to allow the detection of the gauzes present near the operating table.

10. A method for identifying gauzes in a surgery room, wherein each of said gauzes incorporates at least one means containing identification data for remotely detecting the presence of each of said gauzes, characterized by including the steps of:
a) detecting said means containing identification data in the gauzes introduced into the surgery room before the patient operation;
b) transmitting the identification data of each gauze to a processing apparatus;
c) storing the identification data of each gauze in said processing apparatus;
d) detecting said means containing the identification data in the gauzes dumped in a receptacle for collecting the gauzes used during the patient operation;
e) transmitting the identification data of each used gauze to said processing apparatus; and
f) real time updating the identification data of each gauze in said processing apparatus.

11. The method according to claim 10, wherein the count of the gauzes introduced in said surgery room is executed before the patient operation.

12. The method according to claim 10, wherein the count of the gauzes collected in said receptacle is executed during the patient operation.

13. The method according to claim 10, wherein the count of the unused gauzes is executed after the patient operation.

14. The method according to claim 10, wherein the detection of said means containing identification data is carried out in the gauzes possibly near the operating table before ending the patient operation.

15. The method according to claim 10, wherein the expiration date of the gauzes introduced in said surgery room is verified before the patient operation.

16. The method according to claim 10, wherein said means containing identification data incorporated in each of said gauzes is a passive transponder of the RFID type.
